(19) United States
(12) Patent Application Publication
(10) Pub. No.: US 2018/0043316 A1
(43) Pub. Date: Feb. 15, 2018

(54) AERATION OF LIQUID SUITABLE FOR AQUEOUS WASTE TREATMENT

(71) Applicant: ARIEL SCIENTIFIC INNOVATIONS LTD, Ariel (IL)

(72) Inventors: Yaakov Anker, Salit (IL); Adi Nocham, Kfar Saba (IL)

(21) Appl. No.: 15/790,291

(22) Filed: Oct. 23, 2017

Related U.S. Application Data
(63) Continuation of application No. 14/365,999, filed on Jun. 17, 2014, now abandoned.
(60) Provisional application No. 61/577,097, filed on Dec. 19, 2011.

(51) Int. Cl. B01F 3/04; B01F 5/10; B01F 5/04; C02F 3/20; C02F 3/12; F04F 5/46; B01F 5/02; C02F 101/10

(52) U.S. Cl. CPC B01F 3/04099; F04F 5/463; B01F 5/106; B01F 3/04439; B01F 3/0446; B01F 5/0212; B01F 5/0415; C02F 3/20; C02F 3/1294; B01F 5/043; B01F 5/0423; B01F 2215/0052; Y02W 10/15; B01F 2003/04872; C02F 2101/10; C02F 2203/006

(57) ABSTRACT

Disclosed are methods and devices useful for aerating and or adding additives to carbon-containing aqueous waste.

### RELATED APPLICATION

The present application gains priority from U.S. Provisional Patent Application No. 61/577,097 filed 19 Dec. 2011, which is included by reference as if fully set-forth herein.

### FIELD AND BACKGROUND OF THE INVENTION

The invention, in some embodiments, relates to the field of water treatment, and more particularly, but not exclusively, to methods and devices for treatment of aqueous waste. The invention, in some embodiments, relates to the field of aeration, and more particularly, but not exclusively, to methods and devices useful for aerating liquid streams, for example, in the field of processing carbon-containing aqueous waste. The invention, in some embodiments, relates to the field of waste processing, and more particularly, but not exclusively, to methods and devices suitable for adding additives useful in the field of aqueous waste processing.

Aqueous waste such as wastewater is water that contains contaminants including organic contaminants.

The amount of organic contaminants in aqueous waste is often expressed in terms of BOD or COD in units of mg/L. BOD (biological oxygen demand) is the mass of oxygen required for digestion of biodegradable contaminants in the aqueous waste by microorganisms. COD (chemical oxygen demand) is the mass of oxygen required for chemical oxidation of organic contaminants in the aqueous waste.

Total dissolved solids (TDS) in mg/L refers to minerals, salts, metals, cations, anions and small amounts of organic matter dissolved in the aqueous waste.

Total suspended solids (TSS) in mg/L refer to small suspended or colloidal particles that do not settle from the aqueous waste due to gravity alone.

In some cases, a measure of a specific type of contaminant, for example aromatic or metal content, in aqueous waste is also given.

Aqueous waste can be classified as untreated or raw (generally having a BOD>300 mg/L or a high chemical load) or as treated. Treated aqueous waste is aqueous waste that has been treated to have a certain organic contaminant level: Grade A: BOD<20 mg/L; Grade B: 20<BOD<150 mg/L; or Grade C: 150<BOD<300 mg/L.

Aqueous waste treatment is a process for removing contaminants from the waste to produce a liquid and a solid (sludge) phase, where the liquid phase in suitable for reuse discharge, for example, being free of odors, suspended solids, and pathogenic bacteria

There are a number of typical stages of large-scale aqueous waste treatment.

In an initial stage (primary treatment), the aqueous waste is clarified: floating solids and hydrophobic materials are removed, e.g., by raking or skimming, respectively, together with or followed by settling of sludge.

In a following stage (secondary treatment), most of the organic contaminants in the liquid effluent from the initial stage are removed, typically by aerobic digestion in an aerobic digester for example using aerobic bacteria, to biologically oxidise organic contaminants. The resulting product settles as a coagulated mass (floc). To increase the rate of aerobic digestion, the aqueous waste is typically aerated during the aerobic digestion.

If sufficient oxygen is present in the aqueous waste, aerobic digestion processes remove organic load faster than anaerobic and anoxic processes. In large-scale aqueous waste treatment, aqueous waste is aerated by forcing atmospheric air through a diffuser at the bottom of the vessel in which the aerobic digestion takes place, see for example U.S. Pat. No. 4,818,446.

It is also known to aerate aqueous waste by generating a jet of the aqueous waste to draw air thereinto using the Bernoulli effect, for example U.S. Pat. No. 5,322,222.

The Bernoulli Effect has also been used to draw water into a jet of a gas, for example U.S. Pat. No. 6,595,163.

### SUMMARY OF THE INVENTION

The invention, in some embodiments thereof, relates to aerators and methods of aerating carbon-containing aqueous waste that, in some aspects, have advantages over known, aerators and methods.

According to an aspect of some embodiments of the invention, there is provided a method of aerating carbon-containing liquid aqueous waste, comprising:

providing a first aerator including:
a body having a solid wall defining a fluid-flow channel with a longitudinal axis passing between a proximal aperture and a distal aperture of the body, and at least one peripheral hole providing fluid communication between the outside of the wall and the fluid-flow channel; and disposed through the proximal aperture and inside the fluid-flow channel, a nozzle with a nozzle inlet and a nozzle outlet smaller than the nozzle inlet,
   while the first aerator is submerged in carbon-containing liquid aqueous waste, driving an oxygen-containing gas (e.g., air) into the inlet of the nozzle of the first aerator to form a gas stream emerging from the nozzle outlet, so as to draw the liquid aqueous waste through at least one peripheral hole of the first aerator into the gas stream (as a result of Bernoulli's principle), thereby aerating the liquid that exits the fluid-flow channel of the first aerator through the distal aperture of the first aerator.

According to an aspect of some embodiments of the invention, there is also provided a method of aerating carbon-containing liquid aqueous waste, comprising:

providing a first aerator including
a body having a solid wall defining a fluid-flow channel with a longitudinal axis passing between a proximal aperture and a distal aperture, and at least one peripheral hole providing fluid communication between the outside of the wall and the fluid-flow channel; and disposed through the proximal aperture and inside the fluid-flow channel, a nozzle with a nozzle inlet and a nozzle outlet smaller than the nozzle inlet,
   while the first aerator is located in an oxygen-containing gas (e.g., ambient air), driving carbon-containing liquid aqueous waste into the inlet of the nozzle of the first aerator to form a liquid stream emerging from the nozzle outlet, so as to draw the gas through at least one peripheral hole of the first aerator into the liquid stream (as a result of Bernoulli's principle), thereby aerating the liquid that exits the fluid-flow channel of the first aerator through the distal aperture of the first aerator.

According to an aspect of some embodiments of the invention, there is also provided an aerator kit, useful for aerating carbon-containing aqueous waste, comprising:

a body component including:
a solid wall defining a fluid-flow channel with a longitudinal axis between a proximal aperture and a distal aperture thereof; and
at least one peripheral hole providing fluid communication between the outside of the wall and the fluid-flow channel of the body component; at least one nozzle insert, physically separate from the body component, each nozzle insert including:
a solid wall defining a truncated conical fluid-flow channel with a longitudinal axis convergent from a nozzle insert inlet to a nozzle insert outlet smaller than the nozzle insert inlet;
a distal outer portion having a truncated conical cross section having a length and ending at the nozzle insert outlet; and
a proximal mating portion,
   wherein each of the nozzle inserts is configured to mate with the body component, thereby together constituting a single physical unit, where:
the mating portion of the nozzle insert mates with the proximal aperture of the body component;
the distal outer portion of the nozzle insert is located inside the fluid-flow channel of the body component; and
the distal outer portion of the nozzle insert extends beyond, without blocking, the at least one peripheral hole.

According to an aspect of some embodiments of the invention, there is also provided an aerobic digester, comprising an aerator assembled from an aerator kit as described herein.

According to an aspect of some embodiments of the invention there is also provided a method of adding an additive to a carbon-containing liquid aqueous waste, comprising:
providing an additive-adding aerator including:
   a body having a solid wall defining a fluid-flow channel with a longitudinal axis passing between a proximal aperture and a distal aperture of the body, and at least one peripheral hole providing fluid communication between the outside of the wall and the fluid-flow channel;
   disposed through the proximal aperture and inside the fluid-flow channel, a nozzle with a nozzle inlet and a nozzle outlet smaller than the nozzle inlet;
   an additive reservoir holding an additive (in some embodiments a liquid, in some embodiments a gas) having an opening functionally-associated with at least one peripheral hole
driving a fluid into the inlet of the nozzle of the aerator to form a fluid stream emerging from the nozzle outlet, so as to draw additive from the reservoir into the fluid stream through a peripheral hole
thereby adding additive into the fluid that exits the fluid-flow channel of the aerator through the distal aperture of the aerator.

Unless otherwise defined, all technical and scientific terms used herein have the same meaning as commonly understood by one of ordinary skill in the art to which the invention pertains. In case of conflict, the specification, including definitions, will control.

As used herein, the terms “comprising”, “including”, “having” and grammatical variants thereof are to be taken as specifying the stated features, integers, steps or components but do not preclude the addition of one or more additional features, integers, steps, components or groups thereof.

As used herein, the indefinite articles “a” and “an” mean “at least one” or “one or more” unless the context clearly dictates otherwise.

As used herein, when a numerical value is preceded by the term “about” the term “about” is intended to indicate +/−10%.

### BRIEF DESCRIPTION OF THE FIGURES

Some embodiments of the invention are described herein with reference to the accompanying figures. The description, together with the figures, makes apparent to a person having ordinary skill in the art how some embodiments of the invention may be practiced. The figures are for the purpose of illustrative discussion and no attempt is made to show structural details of an embodiment in more detail than is necessary for a fundamental understanding of the invention. For the sake of clarity, some objects depicted are not to scale. In the Figures:

FIG. 1A is a schematic depictions of an embodiment of an aerobic digester according to the teachings herein useful for implementing embodiments of a method of aerating carbon-containing liquid aqueous waste using a stream of air according to the teachings herein;

FIG. 1B is a schematic depictions of an embodiment of an aerobic digester according to the teachings herein useful for implementing embodiments of a method of aerating carbon-containing liquid aqueous waste using a stream of air according to the teachings herein;

FIG. 2A is a schematic depictions of an embodiment of an aerobic digester according to the teachings herein useful for implementing embodiments of a method of aerating carbon-containing liquid aqueous waste using a stream of liquid aqueous waste according to the teachings herein;

FIG. 2B is a schematic depictions of an embodiment of an aerobic digester according to the teachings herein useful for implementing embodiments of a method of aerating carbon-containing liquid aqueous waste using a stream of liquid aqueous waste according to the teachings herein;

FIG. 3A is a depiction of a body component of an embodiment of an aerator kit according to the teachings herein, in perspective view from the proximal end;

FIG. 3B is a depiction of a nozzle insert for making a liquid stream, for use with the body component depicted in FIG. 3A, in cross section;

FIG. 3C is a depiction of a nozzle insert for making a gas stream, for use with the body component depicted in FIG. 3A, in cross section;

FIG. 3D is a depiction of a nozzle insert of FIG. 3B mated with the body component depicted in FIG. 3A, in cross section;

FIG. 3E is a depiction of a nozzle insert of FIG. 3C mated with the body component depicted in FIG. 3A, in cross section;

FIG. 4A is a depiction of a body component suitable for use as an aerator for making a liquid stream of an embodiment of an aerator kit according to the teachings herein, in cross section; and

FIG. 4B is a depiction of a nozzle insert for making a gas stream, for use with the body component depicted in FIG. 4A, in cross section.

### DESCRIPTION OF SOME EMBODIMENTS OF THE INVENTION

The invention, in some embodiments thereof, relates to aerators and methods of aerating carbon-containing aqueous waste that, in some aspects, have advantages over known, aerators and methods. Specifically, some embodiments of the methods and aerators described herein are exceptionally useful for aerating carbon-containing aqueous waste in order to improve (increase the rate of) aerobic digestion thereof. In some embodiments, implementation of the teachings herein results in a reduction of carbon dioxide emissions during aqueous waste processing when compared to other aeration method.

The invention, in some embodiments thereof, relates to aerators and methods of aeration that, in some aspects, have advantages over known, aerators and methods. In some embodiments, there is provided an aerator suitable for aerating aqueous waste comprising a

Venturi tube. In some embodiments, there is provided a method of aerating a liquid stream with the use of a Venturi tube. In some embodiments, aeration is achieved by drawing the aqueous waste into a gas stream, typically of an oxygen-containing gas such as air. In some embodiments, aeration is achieved by drawing a gas, typically an oxygen-containing gas such as air into a stream of the aqueous waste.

The principles, uses and implementations of the teachings of the invention may be better understood with reference to the accompanying description and figures. Upon perusal of the description and figures present herein, one skilled in the art is able to implement the teachings of the invention without undue effort or experimentation. In the figures, like reference numerals refer to like parts throughout.

Before explaining at least one embodiment of the invention in detail, it is to be understood that the invention is not necessarily limited in its application to the details of construction and the arrangement of the components and/or methods set forth herein. The invention is capable of other embodiments or of being practiced or carried out in various ways. The phraseology and terminology employed herein are for descriptive purpose and should not be regarded as limiting.

It is known to process carbon-containing aqueous waste (e.g., sewage) by aerobic digestion. The aqueous waste is held in an aerobic digester for a period of time to allow aerobic microorganisms to digest the waste. It is known to aerate such waste by the introduction of an oxygen-containing gas such as air into the waste. Typically aeration is performed with a diffuser or an air-lift: a blower or compressor is used to release air near the bottom of the aerobic digester. As the released air rises to the surface of the aerobic digester, the aqueous waste is mixed (often also including relatively dense sediment) and some oxygen from the released air is dissolved in the aqueous waste, improving the aerobic digestion. Such aeration methods have the advantage of simplicity and relatively low maintenance. However, such aeration methods lead to the release substantial quantities of carbon dioxide dissolved in the aqueous waste into the atmosphere and have been found to be relatively ineffective in aeration.

It has been found by the Inventors and is herein disclosed that in some embodiments, aeration of carbon-containing liquid aqueous waste using Bernoulli's principle, whether by drawing aqueous waste into a stream of an oxygen-containing gas such as air, or by drawing an oxygen-containing gas such as air into a stream of aqueous waste leads to the release of less carbon dioxide from the aqueous waste in the atmosphere and/or leads to substantially more efficient aeration.

It has been found that in some embodiments of the teachings herein, the same amount of energy (e.g., as electricity) used to operate a blower or a compressor for air-lift aeration leads to significantly greater aeration of the aqueous waste and a concomitant far higher effective capacity (amount of waste processed per unit time) of an aerobic digester.

Some embodiments of the teachings herein allow increasing the effective capacity of an aerobic digester at low-cost by using an existing blower or compressor previously used to aerate by diffusion or air-lift, to generate a stream of air in an aerator such as described herein that is immersed in liquid aqueous waste of an aerobic digester, so that the aqueous waste is drawn into the stream of air, thereby aerating the waste. Not only do such embodiments allow saving money by allowing avoiding the need to buy a new and expensive blower or compressor, but a greater waste-processing capacity is achieved for the same costs of operating (especially, energy and maintenance) a blower or a compressor.

Alternatively, some embodiments of the teachings herein allow increasing the effective capacity of an aerobic digester at low-cost by using a pump to pump liquid aqueous waste from an aerobic digester to generate a stream of liquid aqueous waste in an aerator such as described herein that is located in the ambient air, so that air is drawn into the stream of aqueous waste, thereby aerating the waste. Such embodiments provide greater waste-processing capacity for the same costs of operating (especially, energy and maintenance) a blower or compressor.

### Method of Aeration Using a Gas Stream

As noted above, in some embodiments of the teachings herein, a liquid such as carbon-containing liquid aqueous waste is effectively aerated by drawing the liquid into a stream of an oxygen-containing gas such as air using Bernoulli's principle

Thus, according to an aspect of some embodiments of the teachings herein there is provided a method of aerating carbon-containing liquid aqueous waste, comprising:

providing a first aerator including:
a body having a solid wall defining a (preferably substantially straight) fluid-flow channel with a longitudinal axis passing between a proximal aperture and a distal aperture of the body, and at least one peripheral hole providing fluid communication between the outside of the wall and the fluid-flow channel; and
disposed through the proximal aperture and inside the fluid-flow channel, a nozzle with a nozzle inlet and a nozzle outlet smaller than the nozzle inlet,
while the first aerator is submerged in carbon-containing liquid aqueous waste, driving an oxygen-containing gas (preferably air) into the inlet of the nozzle of the first aerator to form a gas stream emerging from the nozzle outlet, so as to draw the liquid aqueous waste through at least one the peripheral hole of the first aerator into the gas stream (as a result of Bernoulli's principle),
   thereby aerating the liquid that exits the fluid-flow channel of the first aerator through the distal aperture of the first aerator.

In some embodiments, the solid wall of the body of the first aerator is substantially tubular. In some embodiments, at least one peripheral hole is distinct from the proximal and distal apertures. In some embodiments, all of the peripheral holes are distinct from the proximal and distal apertures.

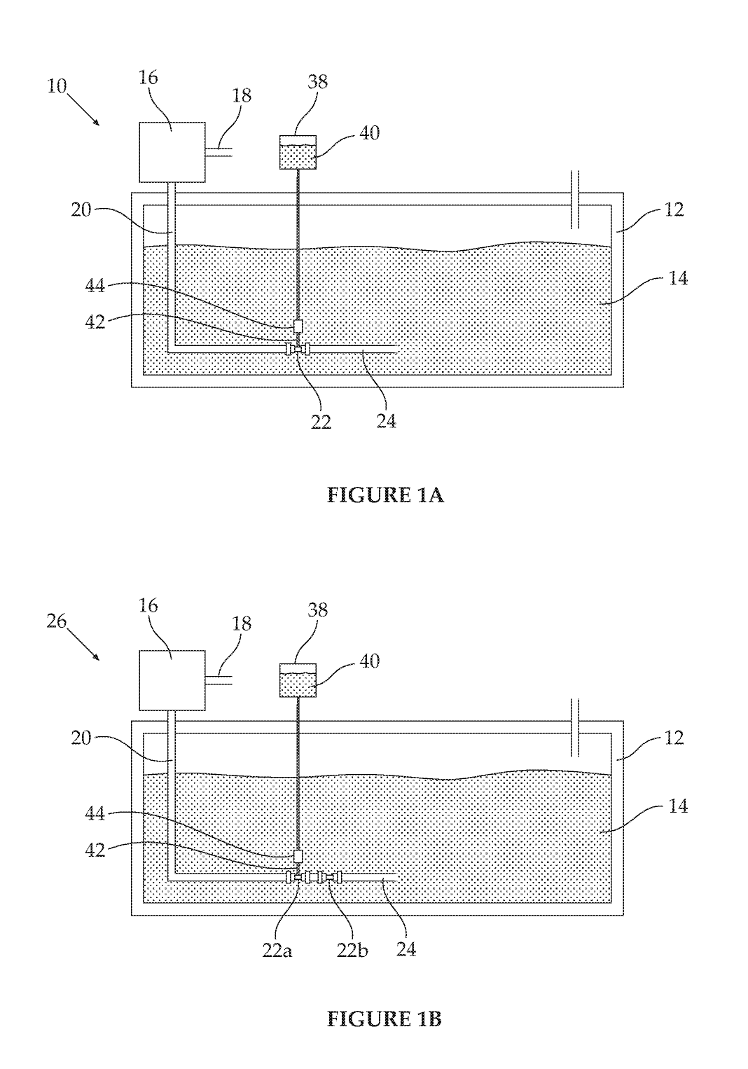

In FIG. 1A, an aerobic digester 10 implementing an embodiment of the method of aerating carbon-containing liquid aqueous waste described hereinabove is schematically depicted in side cross-section. Aerobic digester 10 includes a vessel 12 holding a carbon-containing liquid aqueous waste 14 for aerobic digestion. Compressor 16 is configured to take ambient air in through a compressor inlet 18 and force the air out through a compressor outlet 20, driving the air through an aerator 22 that is submerged in liquid aqueous waste 14.

As described above, compressor 16 drives the air into a nozzle inlet of aerator 22 to form a gas stream that emerges from a nozzle outlet of aerator 22. Liquid aqueous waste 14 is drawn into the gas stream through peripheral holes in aerator 22 as a result of Bernoulli's principle, thereby aerating the liquid aqueous waste that is returned to vessel 12 through outlet pipe 24.

In some embodiments, such as depicted in FIG. 1A, a single aerator used in accordance with the teachings herein provides a sufficient degree of aeration. In some embodiments, two aerators are provided in parallel to provide a greater degree of aeration. By parallel is meant that both aerators are submerged and oxygen-containing gas is driven through both at the same time (e.g., both by the same device such as a blower or compressor, or each with different device such as a blower or compressor).

That said, in some embodiments, two aerators are serially-linked to provide a greater degree of aeration. By serially-linked is meant that the aerated liquid exiting the first aerator from the distal aperture is fed into the nozzle inlet of a second aerator. The previously-aerated liquid is subsequently aerated a second time as a result of Bernoulli's principle when passing through the second aerator.

Thus, in some embodiments the method of aerating carbon-containing liquid aqueous waste above further comprises:

providing a second aerator including:
a body having a solid wall defining a (preferably substantially straight) fluid-flow channel with a longitudinal axis passing between a proximal aperture and a distal aperture of the body, and at least one peripheral hole providing fluid communication between the outside of the wall and the fluid-flow channel; and
disposed through the proximal aperture and inside the fluid-flow channel of the second aerator, a nozzle with a nozzle inlet and a nozzle outlet smaller than the nozzle inlet,
   serially linking the second aerator to the first aerator, so that fluid exiting the fluid-flow channel of the first aerator through the distal aperture of the first aerator enters the inlet of the nozzle of the second aerator;
   submerging the second aerator together with the first aerator in the carbon-containing liquid waste;
   while the oxygen-containing gas is driven into the inlet of the nozzle of the first aerator, the aerated liquid that exits the fluid-flow channel of the first aerator through the distal aperture of the first aerator enters the inlet of the nozzle of the second aerator to form a liquid stream emerging from the nozzle outlet of the second aerator, so as to draw the liquid through at least one peripheral hole of the second aerator into the liquid stream passing therethrough, thereby aerating the liquid that exits the fluid-flow channel of the second aerator through the distal aperture of the second aerator (as a result of Bernoulli's principle).

In some embodiments, the solid wall of the body of the second aerator is substantially tubular. In some embodiments, at least one peripheral hole of the second aerator is distinct from the proximal and distal apertures. In some embodiments, all of the peripheral holes of the second aerator are distinct from the proximal and distal apertures.

In some embodiments, the first and second aerators are substantially different. In some embodiments, the first and second aerators are substantially the same.

In some preferred embodiments, the serially-linked first and second aerators are coaxial.

In FIG. 1B, an aerobic digester 26 implementing an embodiment of the method of aerating carbon-containing liquid aqueous waste described hereinabove is schematically depicted in side cross section. Aerobic digester 26 is substantially identical to aerobic digester 10 depicted in FIG. 1A, but includes two distinct substantially identical aerators 22a and 22b coaxially serially-linked, both submerged in liquid aqueous waste 14.

As described above, compressor 16 drives air into a nozzle inlet of first aerator 22a to form a gas stream that emerges from a nozzle outlet of first aerator 22a. Liquid aqueous waste 14 is drawn into the gas stream through peripheral holes in first aerator 22a as a result of Bernoulli's principle, thereby aerating the liquid aqueous waste. The thus-aerated liquid aqueous waste exits the fluid-flow channel of first aerator 22a through the distal aperture of first aerator 22a and enters the inlet of the nozzle of second aerator 22b, forming a liquid stream that emerges from the nozzle outlet of second aerator 22b. Liquid aqueous waste 14 is drawn into the liquid stream through peripheral holes in second aerator 22b as a result of Bernoulli's principle, thereby aerating the liquid aqueous waste that is returned to vessel 12 through outlet pipe 24.

### Method of Aeration Using a Liquid Stream

As noted above, in some embodiments of the teachings herein, a liquid such as carbon-containing liquid aqueous waste is effectively aerated by drawing an oxygen-containing gas such as air into a stream of the liquid using Bernoulli's principle

Thus, according to an aspect of some embodiments of the teachings herein there is also provided a method of aerating carbon-containing liquid aqueous waste, comprising:

providing a first aerator including:
a body having a solid wall defining a (preferably substantially straight) fluid-flow channel with a longitudinal axis passing between a proximal aperture and a distal aperture of the body, and at least one peripheral hole providing fluid communication between the outside of the wall and the fluid-flow channel; and
disposed through the proximal aperture and inside the fluid-flow channel, a nozzle with a nozzle inlet and a nozzle outlet smaller than the nozzle inlet,
   while the first aerator is located in an oxygen-containing gas (preferably ambient air), driving carbon-containing liquid aqueous waste into the inlet of the nozzle of the first aerator to form a liquid stream emerging from the nozzle outlet, so as to draw the gas through at least one peripheral hole of the first aerator into the liquid stream (as a result of Bernoulli's principle), thereby aerating the liquid aqueous waste that exits the fluid-flow channel of the first aerator through the distal aperture of the first aerator.

In some embodiments, the solid wall of the body of the first aerator is substantially tubular. In some embodiments, at least one peripheral hole is distinct from the proximal and distal apertures. In some embodiments, all of the peripheral holes are distinct from the proximal and distal apertures.

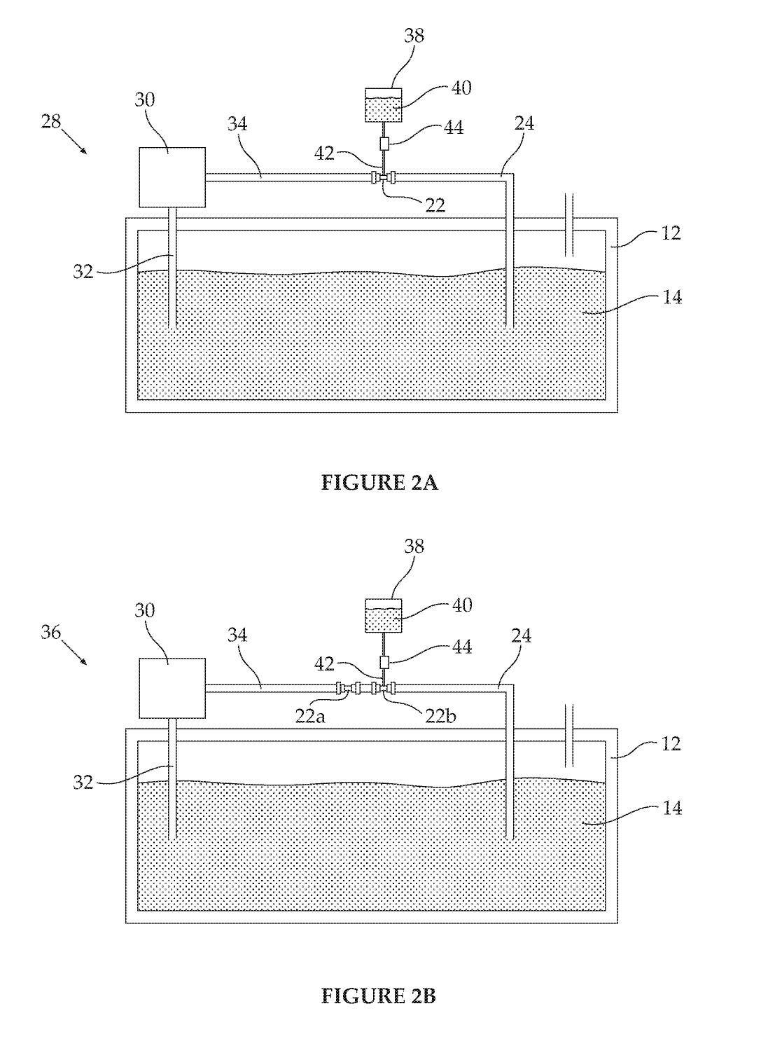

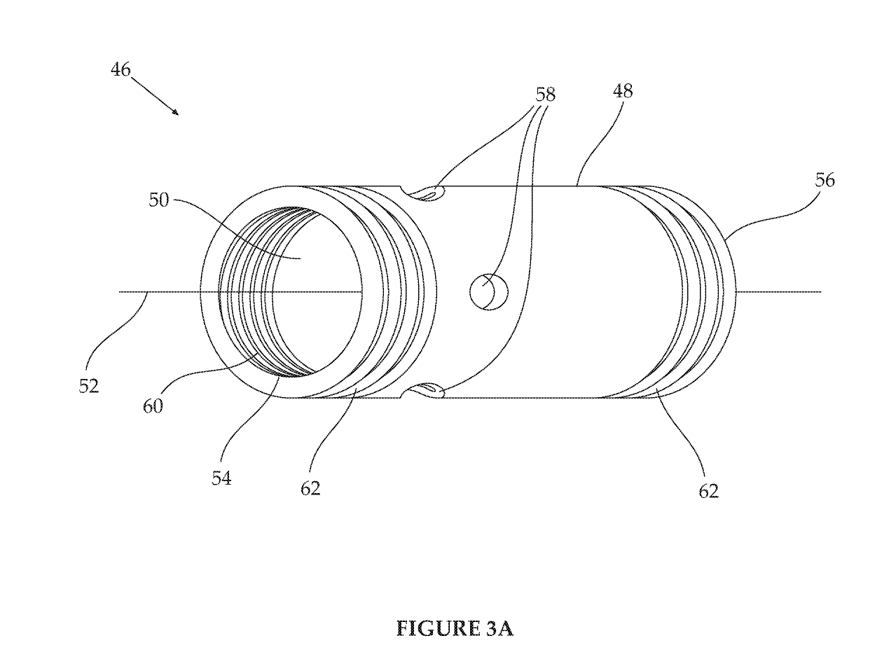

In FIG. 2A, an aerobic digester 28 implementing an embodiment of the method of aerating carbon-containing liquid aqueous waste described hereinabove is schematically depicted in side cross-section. Aerobic digester 28 includes a vessel 12 holding a carbon-containing liquid aqueous waste 14 for aerobic digestion. Pump 30 is configured to take aqueous waste 14 through a pump inlet 32 and force the liquid aqueous waste out through a pump outlet 34, driving the liquid aqueous waste through an aerator 22 that is located in the ambient air.

As described above, pump 30 drives the liquid aqueous waste into a nozzle inlet of aerator 22 to form a liquid stream that emerges from a nozzle outlet of aerator 22. Ambient air is drawn into the liquid stream through peripheral holes in aerator 22 as a result of Bernoulli's principle, thereby aerating the liquid aqueous waste that is returned to vessel 12 through outlet pipe 24.

In some embodiments, such as depicted in FIG. 2A, a single aerator used in accordance with the teachings herein provides a sufficient degree of aeration.

In some embodiments, two aerators are provided in parallel to provide a greater degree of aeration. By parallel is meant that both aerators are located in an oxygen-containing gas such as ambient air, and liquid aqueous waste is driven through both at the same time (e.g., both by the same device such as a pump, or each with different device such as a pump).

That said, in some embodiments, two aerators are serially-linked to provide a greater degree of aeration. By serially-linked is meant that the aerated liquid exiting the first aerator from the distal aperture is fed into the nozzle inlet of a second aerator. The previously-aerated liquid is subsequently aerated a second time as a result of Bernoulli's principle when passing through the second aerator.

Thus, in some embodiments the method of aerating carbon-containing liquid aqueous waste above further comprises:

providing a second aerator including:
a body having a solid wall defining a (preferably substantially straight) fluid-flow channel with a longitudinal axis passing between a proximal aperture and a distal aperture of the body, and at least one peripheral hole providing fluid communication between the outside of the wall and the fluid-flow channel; and
disposed through the proximal aperture and inside the fluid-flow channel of the second aerator, a nozzle with a nozzle inlet and a nozzle outlet smaller than the nozzle inlet,
   serially linking the second aerator to the first aerator, so that fluid exiting the fluid-flow channel of the first aerator through the distal aperture of the first aerator enters the inlet of the nozzle of the second aerator;
   locating the second aerator together with the first aerator in an oxygen-containing gas (preferably ambient air);
   while the liquid aqueous waste is driven into the inlet of the nozzle of the first aerator, the aerated liquid that exits the fluid-flow channel of the first aerator through the distal aperture of the first aerator enters the inlet of the nozzle of the second aerator to form a liquid stream emerging from the nozzle outlet of the second aerator, so as to draw the oxygen-containing gas through at least one the peripheral hole of the second aerator into the liquid stream passing therethrough,
   thereby aerating the liquid that exits the fluid-flow channel of the second aerator through the distal aperture of the second aerator as a result of Bernoulli's principle.

In some embodiments, the solid wall of the body of the second aerator is substantially tubular. In some embodiments, at least one peripheral hole of the second aerator is distinct from the proximal and distal apertures. In some embodiments, all of the peripheral holes of the second aerator are distinct from the proximal and distal apertures.

In some embodiments, the first and second aerators are substantially different. In some embodiments, the first and second aerators are substantially the same.

In some preferred embodiments, the serially-linked first and second aerators are coaxial.

In FIG. 2B, an aerobic digester 36 implementing an embodiment of the method of aerating carbon-containing liquid aqueous waste described hereinabove is schematically depicted in side cross-section. Aerobic digester 36 is substantially identical to aerobic digester 28 depicted in FIG. 2A, but includes two distinct identical aerators 22a and 22b coaxially serially-linked, both located in ambient air.

As described above, pump 30 drives liquid aqueous waste into a nozzle inlet of first aerator 22a to form a liquid stream that emerges from a nozzle outlet of first aerator 22a. Ambient air is drawn into the liquid stream through peripheral holes in aerator 22a as a result of Bernoulli's principle, thereby aerating the liquid aqueous waste. The thus-aerated liquid aqueous waste exits the fluid-flow channel of first aerator 22a through a distal aperture of first aerator 22a and enters the inlet of the nozzle of second aerator 22b, forming a liquid stream that emerges from the nozzle outlet of second aerator 22b. Ambient air is drawn into the liquid stream through peripheral holes in second aerator 22b as a result of Bernoulli's principle, thereby aerating the liquid aqueous waste that is returned to vessel 12 through outlet pipe 24.

### Adding Additives Using an Aerator

In some embodiments, it is desired to add an additive (typically a liquid or a gas) to influence the aerobic digestion in an aerobic digester, for example, adding an oxidizing agent, a disinfectant or a nutrient. It is typically desired that such an additive be well-mixed with the aqueous fluid waste, for maximum effect and to prevent agglomeration, sedimentation, binding or volatilization of the additive that may occur if added as a bolus or concentrated stream.

In some embodiments of the teachings herein, addition of an additive is achieved using an additive-adding aerator. Specifically, an opening of a reservoir of additive is functionally associated with at least one peripheral hole of the aerator. During operation, the additive to be added is drawn from the reservoir into the fluid-flow channel of the aerator through the peripheral hole as a result of Bernoulli's principle, to mix with the liquid or gas stream. In some embodiments, aeration using the aerator occurs in the usual way, substantially as described above. In some embodiments, the aerator is dedicated to adding the additive and is not used for aeration.

Thus, according to an aspect of some embodiments of the teachings herein there is also provided a method of adding an additive to a carbon-containing liquid aqueous waste, comprising:
providing an additive-adding aerator including:
   a body having a solid wall defining a fluid-flow channel with a longitudinal axis passing between a proximal aperture and a distal aperture of the body, and at least one peripheral hole providing fluid communication between the outside of the wall and the fluid-flow channel;
   disposed through the proximal aperture and inside the fluid-flow channel, a nozzle with a nozzle inlet and a nozzle outlet smaller than the nozzle inlet;
   an additive reservoir holding an additive (in some embodiments a liquid, in some embodiments a gas) having an opening functionally-associated with at least one peripheral hole
driving a fluid into the inlet of the nozzle of the aerator to form a fluid stream emerging from the nozzle outlet, so as to draw additive from the reservoir into the fluid stream through a peripheral hole
   thereby adding additive into the fluid that exits the fluid-flow channel of the aerator through the distal aperture of the aerator.

In some embodiments, the reservoir opening is functionally associated with the peripheral hole through a valve allowing regulation of an amount of additive entering the fluid stream.

In some embodiments, the fluid is a gas. In some embodiments, the fluid is ambient air. In some embodiments, the fluid is an inert gas such as argon or nitrogen. In some embodiments, the fluid is gas recovered from the head space of an aerobic digester. In some such embodiments, the aerator is configured so that only contents of the reservoir are drawn into the fluid stream through the peripheral holes. In other such embodiments, the aerator is submerged in liquid aqueous waste (e.g., in an aerobic digester) and is configured so that liquid aqueous waste is also drawn into the fluid stream through the peripheral holes.

In some embodiments, the fluid is a liquid, in some embodiments, liquid aqueous waste, for example from an aerobic digester. In some such embodiments, the aerator is configured so that only contents of the reservoir are drawn into the fluid stream through the peripheral holes. In other such embodiments, the aerator is submerged in liquid aqueous waste (e.g., in an aerobic digester) and is configured so that liquid aqueous waste is also drawn into the fluid stream through the peripheral holes.

In some embodiments, the method comprises concurrently using the additive-adding aerator for aeration (e.g., as described herein, for example by using an oxygen-containing gas such as air for the fluid stream, or by drawing an oxygen-containing gas such as air in through the peripheral holes). In some embodiments, the opening of the reservoir does not block a peripheral hole with which functionally associated so that the specific peripheral hole draws the additive into the liquid or gas stream as well as functioning in the usual way for aeration. In some embodiments, a specific peripheral hole is substantially covered by the opening of the reservoir and is thereby dedicated exclusively for drawing the additive into the liquid or gas stream.

In some embodiments, the opening of the reservoir includes a variably-opened valve (e.g., a needle or butterfly valve, remotely or directly operable) that allows an operator to adjust the rate of drawing of an additive into the liquid or gas stream by adjusting the degree at which the valve is open.

In some embodiments, the opening of the reservoir includes a two-state valve (e.g., a gate valve or ball valve remotely or directly operable) that allows an operator to select whether the valve is closed to prevent drawing an additive or opened to allow drawing of the additive into the liquid or gas stream.

In some embodiments, the valve is manually-activated, that is to say, an operator decides when and how much to open the valve to allow addition of an additive.

In some embodiments, the valve is automatically activated according to a schedule, for example, with the help of an automatic device such as a timer and/or computer.

In some embodiments, the valve is functionally associated with a sensor (e.g., directly or through a computer). The sensor monitors a process parameter (for example the concentration of some material in the aqueous waste held in the aerobic digester), and if needed, activates the valve.

According to aspect of some embodiments of the teachings herein, there is also provided a device for implementing the method of adding an additive to a carbon-containing liquid aqueous waste as described herein, such a device comprising an additive-adding aerator, and optionally other components. Typically, an additive-adding aerator is substantially similar or identical in construction and operation to an aeration aerator.

In some embodiments, there is an additive-adding aerator in addition to or instead of an aeration aerator as described above, dedicated exclusively for addition of additives: all the peripheral holes of the additive-adding aerator are functionally associated with and closed by the reservoir. In some embodiments, such an additive-adding aerator is located in parallel relative to at least one aeration aerator. In some embodiments, such an additive-adding aerator is located serially to at least one aeration aerator, downstream or upstream of the at least one aeration aerator, preferably upstream.

Any suitable additive or combination of additives can be added in accordance with the teachings herein, for example, nutrients, oxidizing agents and disinfectants.

Gaseous additives include pure oxygen (O₂), ozone (O₃, in which case the reservoir is typically an ozone generator), fluorine (F₂), chlorine (Cl₂), bromine (Br₂) and iodine (I₂, typically held in the reservoir as a solid and heated to sublimation), chlorine dioxide (ClO₂) and combinations thereof.

Liquid additives include pure and solutions of hydrogen peroxide (H₂O₂), hypochlorous acid (HOCl) and other sources of hypochlorite ions (OCl⁻), sources of oxychloride ions (OCl₃₋), nitric acid (HNO₃), sodium persulfate (Na₂S₂O₈), hydrochloric acid (HCl), sulfuric acid (H₂SO₄), potassium permanganate (KMnO₄), oxalic acid (H₂C₂O₄), as well as solutions (including tinctures) of the gaseous additives listed above, and combinations thereof.

When an aerobic digester includes two aerators in series, typically liquid additives must be added in the upstream (first) aerator.

In FIGS. 1A, 1B, 2A and 2B, a reservoir 38 containing an additive 40 is depicted, which opening 42 is functionally associated with a peripheral hole of an aerator 22. A valve 44 allows regulation of the rate of addition of additive. In some embodiments of FIG. 1B and FIG. 2B, the aerator 22 that is functionally associated with a reservoir 38 is exclusively an additive-adding aerator.

### Aerator Kits

The methods described above are implementable using any suitable aerator. That said, in some embodiments it is preferred to implement the methods using aerators and aerator kits according to the teachings herein.

As discussed in greater detail hereinbelow, some embodiments of an aerator kit according to the teachings herein includes a body component and one or more different nozzle inserts. In some embodiments, the kit comprises a body component with a single nozzle insert. In some embodiments, the kit comprises a body component with two different nozzle inserts.

In some embodiments, the body component is configured to function as an aerator that forms a water stream as discussed above, but when mated with the nozzle insert, is configured to function as an aerator that forms a gas stream.

In some embodiments, to function as an aerator the body component is mated with an nozzle insert, either a nozzle insert allowing functioning as an aerator that forms a gas stream or a different nozzle insert allowing functioning as an aerator that forms a liquid stream.

Thus, according to an aspect of some embodiments of the teachings herein, there is provided an aerator kit, useful for aerating carbon-containing aqueous waste, comprising:

a body component including:
a solid wall defining a (preferably substantially straight) fluid-flow channel with a longitudinal axis between a proximal aperture and a distal aperture thereof; and
at least one peripheral hole providing fluid communication between the outside of the wall and the fluid-flow channel of the body component; at least one nozzle insert, physically separate from the body component, each nozzle insert including:
a solid wall defining a truncated conical fluid-flow channel with a longitudinal axis convergent from a nozzle insert inlet to a nozzle insert outlet smaller than the nozzle insert inlet;
a distal outer portion having a truncated conical cross section having a length and ending at the nozzle insert outlet; and
a proximal mating portion,
   wherein each nozzle insert is configured to mate with the body component, thereby together constituting a single physical unit, where:
the mating portion of the nozzle insert mates with the proximal aperture of the body component;
the distal outer portion of the nozzle insert is located inside the fluid-flow channel of the body component; and
the distal outer portion of the nozzle insert extends beyond, without blocking, the at least one peripheral hole.

In some embodiments, the solid wall of the body component is substantially tubular. In some embodiments, at least one peripheral hole of the body component is distinct from the proximal and distal apertures. In some embodiments, all of the peripheral holes of the body component are distinct from the proximal and distal apertures.

In some embodiments, when mated with the body component, a nozzle insert is coaxial with the fluid-flow channel of the body component.

### Mating

A body component and the associated nozzle insert or inserts may be configured to mate in any suitable fashion using an suitable feature. That said, in some embodiments, a nozzle insert is configured to mate with an inner side of the proximal aperture of the body component, typically allowing an aerator assembled from the kit to have a relatively small footprint.

In some embodiments, the body component and an associated nozzle insert are configured so that when mated, the proximal end of the nozzle insert is flush with the proximal end of the wall of the body component.

In some embodiments, mating is by screwing a nozzle insert into the proximal aperture of the wall of the body component. In typical such embodiments, the outer surface of the mating portion of the nozzle insert includes screw threads configured to engage screw threads on the inside portion of the wall of the body component near the proximal aperture thereof. Thus, in some embodiments, an aerator kit further comprises: screw threads on at least a portion of the inside of the solid wall of the body component near the proximal aperture thereof; and constituting at least a portion of the mating portion of a nozzle insert, screw threads on the proximal outside portion of the nozzle insert configured to mate with the screw threads of the body component.

In some embodiments, mating is by sliding a nozzle insert into the proximal aperture of the wall of the body component. In typical such embodiments, the outer surface of the mating portion of the nozzle insert is smooth and of a diameter that snugly fits in the most proximal portion of the fluid-flow channel of the body component. Typically, inside the fluid-flow channel of the body component is a stop that prevents the nozzle insert from sliding too far distally inside the fluid-flow channel. In some embodiments, the fluid-flow channel of the body component has a larger-diameter portion near the proximal aperture and a smaller-diameter portion distal from the proximal aperture, and the stop is the beginning of the smaller-diameter portion. Thus, in some embodiments, an aerator kit further comprises: the fluid-flow channel of the body component proximal to the proximal aperture having a diameter sufficiently large to allow the mating portion of a nozzle insert to slidingly pass thereinto, and a stop located distally from the proximal aperture in the fluid-flow channel to preventing sliding of the mating portion of the nozzle insert past the stop.

### Peripheral Holes

The number of peripheral holes providing fluid communication between the outside of the wall and the fluid-flow channel of the body component is any suitable number. In some embodiments, there are at least 2, at least 3, at least 4, at least 5 and even at least 6 peripheral holes. In some embodiments, there are 1, 2, 3, 4, 5 or 6 peripheral holes.

The peripheral holes may be of any suitable shape. In some embodiments, at least one peripheral hole is circular. In some embodiments, at least one peripheral hole is oval. In some embodiments at least one peripheral hole is elliptical.

In some embodiments, the peripheral holes have a continuous-sized cross section when passing from the outside of the wall to the fluid-flow channel. In some embodiments, at least one peripheral hole is divergent, having a smaller cross section at the outside of the wall and a larger cross section at the fluid-flow channel. In some embodiments, at least one peripheral hole is convergent, having a larger cross section at the outside of the wall and a smaller cross section at the fluid-flow channel.

The peripheral holes may be oriented in any suitable fashion. In some embodiments, at least one peripheral hole is oriented substantially perpendicularly to the longitudinal axis of the fluid-flow channel of the body component. In some embodiments, at least one peripheral hole is angled towards the distal aperture of the tubular wall of the body component.

### Serial Linking

As discussed above, there may be a need to serially link two aerators. Are accordingly, in some embodiments, the body component of an aerator kit is configured for serial linking to at least one additional such body component. In some embodiments, the body component is configured so that when serially-linked with such an additional body component, the respective fluid-flow channels of the body components are coaxial. For example, in some such embodiments, a body component includes screw threads on the outside surface near both the distal and proximal ends. When it is desired to serially link two such body components, a tubular linker is provided, substantially a pipe having screw threads on an inside surface thereof. The linker is screwed over the distal end of a first body component (of the aerator intended to be an upstream aerator) and also screwed over the proximal end of a second body component (of the aerator intended to be a downstream aerator).

### Body Component Fluid Flow Channel

The fluid-flow channel of the body component has any suitable internal shape.

In some embodiments, perpendicular to the longitudinal axis, the fluid-flow channel of the body component has a circular cross section along the entire length thereof.

In some embodiments, the cross-sectional size of the fluid-flow channel of the body component perpendicular to the longitudinal axis of the fluid-flow channel varies along the length thereof (e.g., has a varying diameter). In some such embodiments, in cross section that includes the longitudinal axis, the fluid-flow channel of the body component has the shape of a convergent nozzle in a distal direction from the peripheral holes. In some such embodiments, in cross section that includes the longitudinal axis and distal from said at least one peripheral hole, the fluid-flow channel of the body component has the shape of a convergent-divergent nozzle.

### Nozzle Insert

As noted above, a nozzle insert has a truncated conical fluid-flow channel convergent from a nozzle insert inlet to a nozzle insert outlet that is smaller than the nozzle insert inlet. The angle of convergence is any suitable angle. That said, in some embodiments, a cross-section including the longitudinal axis of the truncated conical fluid-flow channel of a nozzle insert is an isosceles trapezoid having base angles of between about 30° and about 80°, and in some embodiments between about 45° and about 70°.

As noted above, a nozzle insert has a distal outer portion having a truncated conical cross section having a length and ending at the nozzle insert outlet. The angle of convergence of the distal outer portion is any suitable angle. That said, in some embodiments, a cross-section including the longitudinal axis of the truncated conical distal outer portion of a nozzle insert is an isosceles trapezoid having base angles of between about 30° and about 80°, in some embodiments between about 45° and about 70°. Typically, the convergence angle of the distal outer portion of a nozzle is smaller than the convergence angle of the fluid-flow channel of that nozzle so that the wall of the nozzle insert is thicker at the proximal end and thinner near the nozzle insert outlet.

A given nozzle insert is typically configured for use either in making a gas stream from a gas driven through the nozzle insert fluid-flow channel from the nozzle insert inlet or for making a liquid stream from a liquid driven through the nozzle insert fluid-flow channel from the nozzle insert inlet.

Typically, a nozzle insert configured for making a gas stream is longer than an otherwise equivalent nozzle insert configured for making a liquid stream.

Typically, a nozzle insert configured for making a gas stream has a smaller nozzle insert outlet than an otherwise equivalent nozzle insert configured for making a liquid stream. For example, in some embodiments the outlet of a nozzle insert configured for making a gas stream typically has a cross sectional area of at least about 1/9 and in some embodiments at least about 1/16 of the cross sectional area of the fluid-flow channel of the body component at the place where the nozzle insert outlet is in the fluid-flow channel of the body component when mated therewith. In contrast, in some embodiments the nozzle insert outlet of a nozzle insert configured for making a liquid stream typically has a cross sectional area of between about ½ and about ⅕, and in some embodiments, between about ⅓ and about ¼ of the cross sectional area of the fluid-flow channel of the body component at the place where the nozzle insert outlet is in the fluid-flow channel of the body component when mated therewith.

In some embodiments, a nozzle insert (e.g., one of many or only nozzle insert of an aerator kit) is configured for making a gas stream. Thus, in some embodiments, at least one nozzle insert of the at least one nozzle inserts is configured so that when the body component and the nozzle insert are mated, gas forced into the inlet of the nozzle insert while the body component is immersed in a liquid emerges from the nozzle insert outlet (into the fluid-flow channel of the body component) as a gas stream so as to draw the liquid through at least one peripheral hole into the gas stream. In some such embodiments, in the plane perpendicular to the longitudinal axis of the fluid-flow channel of the body component that includes the nozzle insert outlet when the nozzle insert is mated with the body component, a cross sectional area of the fluid-flow channel of the body component is at least about nine times greater than the cross sectional area of the nozzle insert outlet, and in some embodiments is at least about sixteen times greater than the cross sectional area of the outlet.

In some embodiments, a nozzle insert (e.g., one of many or only nozzle insert of an aerator kit) is configured for making a liquid stream. Thus, in some embodiments, at least one nozzle insert is configured so that when the body component and the nozzle insert are mated, a liquid (e.g., liquid aqueous waste) forced into the inlet of the nozzle insert while the body component is located in ambient air emerges from the nozzle insert outlet (into the fluid-flow channel of the body component) as a liquid stream so as to draw the air through at least one peripheral hole into the liquid stream. In some such embodiments, in the plane perpendicular to the longitudinal axis of the fluid-flow channel of the body component that includes the nozzle insert outlet when the nozzle insert is mated with the body component, a cross sectional area of the fluid-flow channel is between about two and about five times greater than a cross sectional area of the nozzle insert outlet and in some embodiments is between about three and about four times greater than a cross sectional area of the nozzle insert outlet.

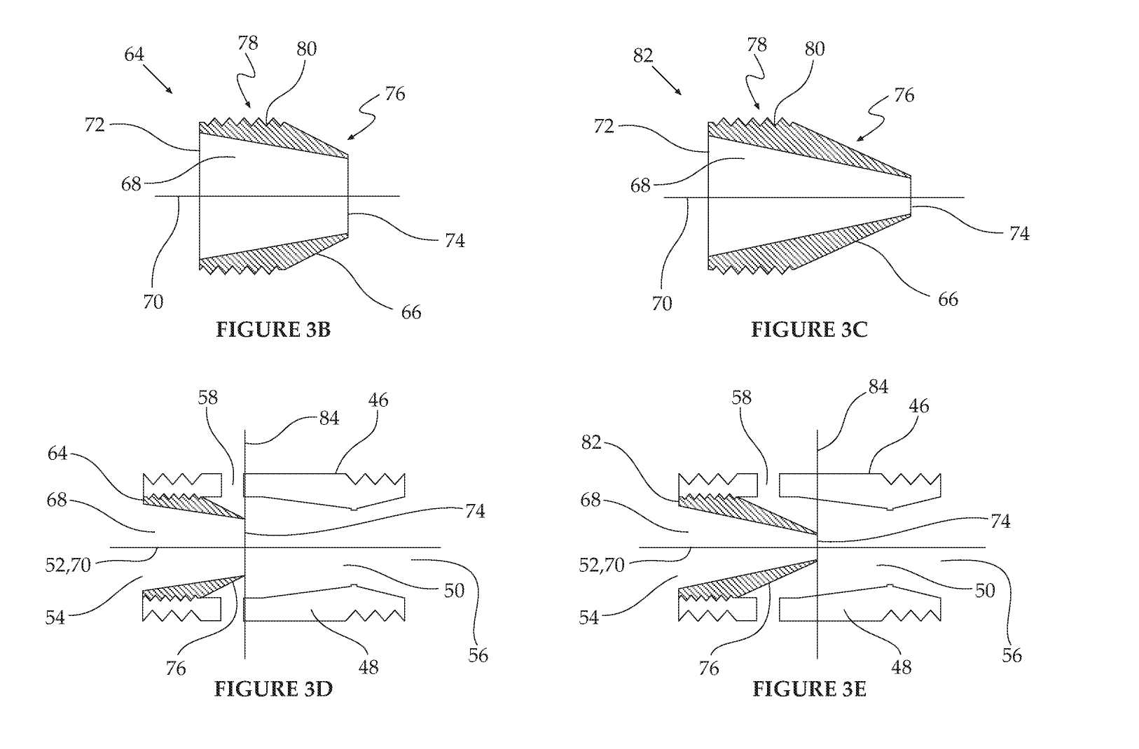

An embodiment of an aerator kit according to the teachings herein is schematically depicted in FIGS. 3A-3E.

In FIG. 3A, a body component 46 of the aerator kit is depicted in perspective view from the proximal end. Body component 46 includes a solid tubular wall 48 defining a fluid-flow channel 50 having a longitudinal axis 52 between a proximal aperture 54 and a distal aperture 56 (see FIGS. 3D and 3E). Three of a total of four circular peripheral holes 58 are seen providing fluid communication between the outside of wall 48 and fluid-flow channel 50. On the inside surface of wall 48 near proximal aperture 54 are seen screw threads 60 for mating with a nozzle insert. On either end of the outside surface of wall 48 near proximal aperture 54 and distal aperture 56 are screw threads 62 suitable for functioning as hose barbs, as attachment components of body component 46 to an aerobic digester, or to allow the use of a linker for coaxial serial linking of body component 46 with another such body component.

In FIG. 3B, a second component of the aerator kit, a liquid-stream nozzle insert 64 for mating with body component 46 configured for making a liquid stream is depicted in side cross section. Nozzle insert 64 includes a solid wall 66 defining a truncated conical fluid-flow channel 68 with a longitudinal axis 70 convergent from a nozzle insert inlet 72 to a nozzle insert outlet 74 that is smaller than the nozzle insert inlet 72. The distal outer portion 76 of nozzle insert 64 has a truncated conical cross section ending at nozzle insert outlet 74. The outer surface of proximal mating portion 78 of nozzle insert 64 includes screw threads 80, configured to mate with screw threads 60 of body component 46.

In FIG. 3C, a third component of the aerator kit, a gas-stream nozzle insert 82 for for mating with body component 46 configured for making an gas stream is depicted in side cross section. Nozzle insert 82 has the same components as nozzle insert 64.

In FIG. 3D, liquid-stream nozzle insert 64 is depicted mated with body component 46 and in FIG. 3E, gas-stream nozzle insert 82 is depicted mated with body component 46, both in side cross section. In FIGS. 3D and 3E is seen how nozzle inserts 64 and 82 mate with body component 46 through screw threads 60 and 80, how when mated, the proximal ends of nozzle inserts 64 and 82 are flush with the proximal end of wall 48 of body component 46 and distal outer portion 76 of nozzle inserts 64 and 82 are located inside fluid-flow channel 50 of body component 46 and are coaxial therewith.

Fluid-flow channel 68 of liquid-stream nozzle insert 64 and of air-stream nozzle insert 82 is in cross section including longitudinal axis 70 an isosceles trapezoid having base angles of about 65°. Distal outer portion 76 of liquid-stream nozzle insert 64 and of air-stream nozzle insert 82 is in cross-section including longitudinal axis 70 an isosceles trapezoid having base angles of about 60°. As seen in FIGS. 3D and 3E, although in both cases distal outer portion 76 extends beyond (without blocking) peripheral holes 58, distal outer portion 76 of air-stream nozzle insert 82 is substantially longer than that of liquid-stream nozzle insert 64. As a consequence, nozzle insert outlet 74 of air-stream nozzle insert 82 is substantially smaller than that of liquid-stream nozzle insert 64.

Perpendicular to longitudinal axis 52, fluid-flow channel 50 of body component 46 has a circular cross section along the entire length thereof with a varying cross sectional size. From proximal aperture 54 to past peripheral holes 58, the cross section is relatively large and constant. Just distally from peripheral holes 58, the radii of the cross sections become progressively smaller so that fluid-flow channel 50 is convergent in the distal direction. Further, the radii of the cross sections become progressively larger so that fluid-flow channel 50 is divergent in the distal direction to distal aperture 56.

As seen in FIG. 3D, in a plane 84 perpendicular to longitudinal axis 52 of fluid-flow channel 50 of body component 46 that includes nozzle insert outlet 74, when liquid-stream nozzle insert 64 is mated with body component 46, a radius of fluid-flow channel 50 is 1.9 times greater than the cross sectional area of nozzle insert outlet 74 so that the cross sectional area of fluid-flow channel 50 is 3.6 times greater than the cross sectional area of nozzle insert outlet 74.

As seen in FIG. 3E, in a plane 84 perpendicular to longitudinal axis 52 of fluid-flow channel 50 of body component 46 that includes nozzle insert outlet 74, when gas-stream nozzle insert 82 is mated with body component 46, a radius of fluid-flow channel 50 is 4 times greater than the cross sectional area of nozzle insert outlet 74 so that the cross sectional area of fluid-flow channel 50 is 16 times greater than the cross sectional area of nozzle insert outlet 74.

As noted above, in some embodiments a body component of an aerator kit according to the teachings herein is configured to function without a nozzle insert as an aerator that forms a water stream as discussed above and when mated with a suitable nozzle insert, is configured to function as an aerator that forms a gas stream. In some such embodiments, an aerator kit comprises the body component and a single nozzle insert. In such embodiments, the body component is configured so that either or both the distal aperture and the proximal aperture constitute a functional equivalent of a nozzle insert inlet.

Thus, in some embodiments, the fluid-flow channel of the body component is configured so that when the body component is not mated with a nozzle insert, liquid forced into an aperture (in some embodiments the proximal aperture, in some embodiments the distal aperture, in some embodiments either the proximal or the distal aperture) while the body component is located in ambient air forms a liquid stream that passes the at least one peripheral hole to draw ambient air through at least one peripheral hole into the liquid stream.

In some such embodiments, the fluid-flow channel of the body component comprises three sections:
a first nozzle section that in a cross section including the longitudinal axis of the body component defines a truncated cone convergent from near the proximal aperture towards the distal aperture;
a second nozzle section that in cross section including the longitudinal axis of the body component defines a truncated cone convergent from near the distal aperture towards the proximal aperture; and
a parallel-walled linking section providing fluid communication between the narrow end of the first nozzle section and the narrow end of the second nozzle section,
   wherein the at least one peripheral hole emerges in the fluid-flow channel at the linking section.

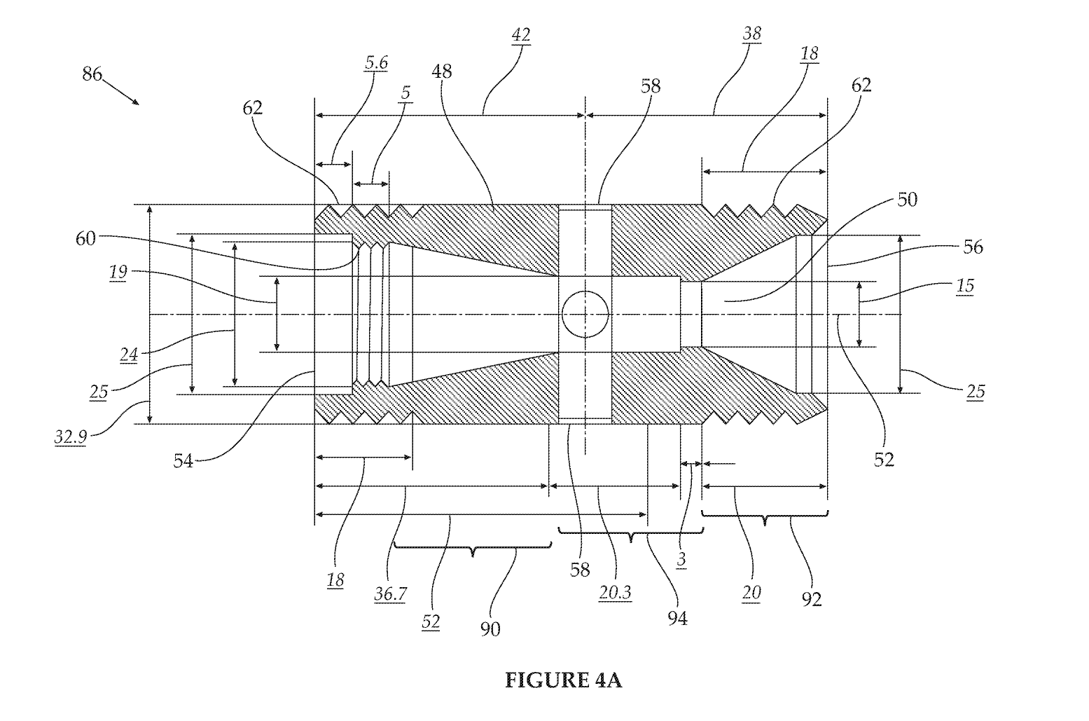

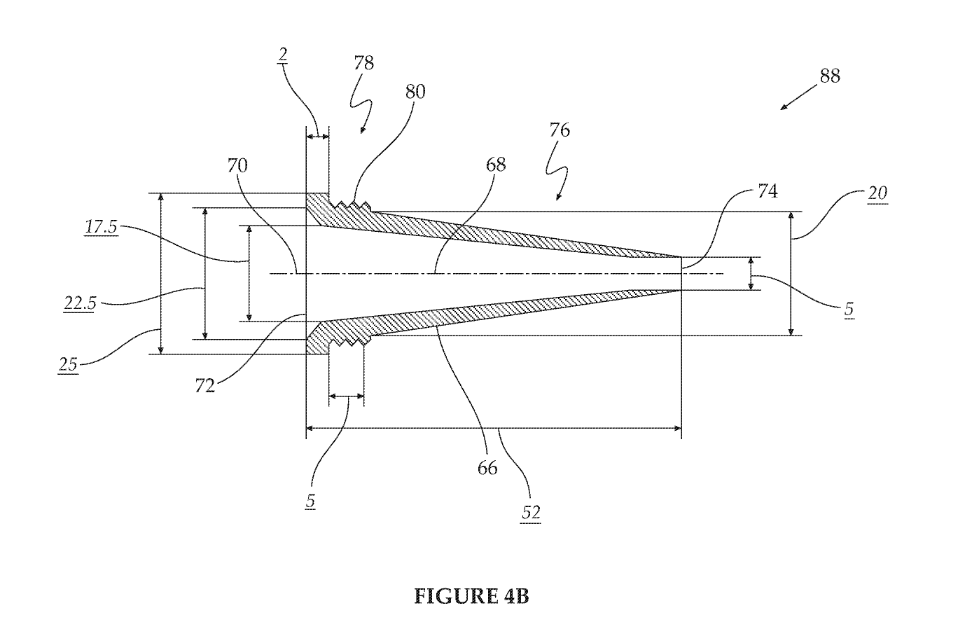

In FIG. 4 an aeration kit according to the teachings herein is depicted. In FIG. 4A, a body component 86 suitable for use as an aerator without a nozzle insert for making a liquid stream is depicted in side cross section. In FIG. 4B, a matching nozzle insert 88 for making a gas stream when mated with body component 86 is depicted in side cross section. In FIG. 4, dimensions of the parts of body component 86 and nozzle insert 88 are given in millimeters in small underlined italic text.

In FIG. 4A, is seen that body component 86 includes many of the same parts as body component 46 depicted in FIG. 3A, including a solid tubular wall 48, a fluid-flow channel 50 having a longitudinal axis 52 between a proximal aperture 54 and a distal aperture 56, peripheral holes 58 and screw threads 60 for mating with nozzle insert 88.

Also seen in FIG. 4A is the configuration of body component 86 to function as an aerator without a nozzle insert: fluid-flow channel 50 comprises three sections: a first nozzle section 90 that in a cross section including longitudinal axis 52 defines a truncated cone convergent from near proximal aperture 54 towards distal aperture 56; a second nozzle section 92 that in cross section including longitudinal axis 52 defines a truncated cone convergent from near distal aperture 56 towards proximal aperture 54; and a parallel-walled linking section 94 providing fluid communication between the narrow end of first nozzle section 90 and the narrow end of second nozzle section 92, wherein peripheral holes 58 emerge in fluid-flow channel 50 at linking section 94.

In FIG. 4B, air-stream nozzle insert 88 configured for mating with body component 86 is depicted in side cross section and has many of the same components as nozzle insert 64 depicted in FIG. 3B and nozzle insert 82 depicted in FIG. 3C including a solid wall 66 defining a truncated conical fluid-flow channel 68 with a longitudinal axis 70 convergent from a nozzle insert inlet 72 to a nozzle insert outlet 74. The outer surface of proximal mating portion 78 of nozzle insert 88 includes screw threads 80, configured to mate with screw threads 60 of body component 86.

For use in aeration (or additive addition) with a liquid stream, body component 86 is located in an oxygen-containing gas. A liquid (e.g., liquid aqueous waste) is driven into distal aperture 56 that constitutes a nozzle inlet into second nozzle section 92 (functioning as a convergent nozzle). The liquid passes through linking section 94 as a stream of liquid. In accordance with Bernoulli's principle, the axial velocity of the liquid stream increases but the pressure of the liquid stream decreases. Due to the reduced pressure in the liquid stream, a gas such as atmospheric air is drawn into the liquid stream through peripheral holes 58 to aerate the liquid. The thus-aerated liquid stream subsequently expands outwards through first nozzle section 90 (functioning as a divergent nozzle) and exits aerator 86 through proximal aperture 54.

For use in aeration (or additive addition) with a gas stream, nozzle insert 88 is mated with body component 86 as described above with the help of screw threads 60 and 80. The combined unit is submerged in a liquid (such as liquid aqueous waste) and a gas is driven into nozzle insert inlet 72 to aerate the liquid as described above.

A person having ordinary skill in the art is able, upon perusal of the specification and the figures, to the implement the teachings herein without undue experimentation. A body component and a nozzle insert according to the teachings herein are fashioned using any suitable technique and any suitable material. Preferred are plastics, especially polyfluorinated hydrocarbons, that are relatively cheap to make at the required tolerances, are resistant to corrosion, and are hydrophobic to discourage settling, sedimentation and biofilm formation in conditions of continuous content with atmospheric oxygen and aqueous waste such as sewage.

### Aerator According to the Teachings Herein

According to an aspect of some embodiments of the invention, there is provided an aerator assembled from an aerator kit according to the teachings herein.

In some embodiments, the aerator is assembled by mating a body component and a nozzle insert of an aerator kit.

### Aerobic Digester

According to an aspect of some embodiments of the invention, there is provided an aerobic digester comprising an aerator assembled from an aerator kit according to the teachings herein.

In some embodiments, the aerator is assembled by mating a body component and a nozzle insert of an aerator kit.

In some embodiments, the aerator is assembled by mating a body component and an air-stream nozzle insert, and the aerobic digester further comprises a component (e.g., a compressor or a blower) for forcing air into the nozzle inlet of the gas-stream nozzle insert of the aerator to form an gas stream emerging from the outlet of the nozzle insert while the aerator is submerged in a liquid (such as liquid aqueous waste) so as to draw the liquid through at least one of the peripheral holes into the gas stream, thereby aerating the liquid.

In some embodiments, the aerator is assembled by mating a body component and a liquid-stream nozzle insert, and the aerobic digester further comprises a component (e.g., a pump) for forcing a liquid (such as liquid aqueous waste) into the inlet of the nozzle insert of the liquid-stream aerator to form a liquid stream emerging from the outlet of the nozzle insert while the aerator is in ambient air so as to draw ambient air through at least one of the peripheral holes into the liquid stream, thereby aerating the liquid.

In some embodiments, the aerator comprises a body component configured to function as a liquid-stream aerator devoid of a nozzle insert, and the digester further comprises a component (e.g., a pump) for forcing a liquid (such as liquid aqueous waste) into a nozzle inlet (e.g., the proximal or distal aperture of the body component) of the aerator to form a liquid stream passing the at least one peripheral holes while the aerator is in ambient air so as to draw ambient air through at least one of the peripheral hole into the liquid stream, thereby aerating the liquid.

### Aqueous Waste Application

In some embodiments, the teachings herein are implemented for processing aqueous waste.

In some embodiments, the aqueous waste is sewage (blackwater) that generally is considered to comprise about 99% water by weight but includes pathogenic bacteria and human faeces.

In some embodiments, the aqueous waste is industrial aqueous waste; for example, waste that comprises about 95% water by weight and about 5% organic compounds (aliphatic and organic) as well as heavy metals.

In some embodiments, the aqueous waste is subjected to aerobic digestion. Generally, the BOD (biochemical oxygen demand) level of the aqueous waste determines whether or not aerobic digestion is performed prior to settling. For example, in some embodiments, if the BOD of the waste is greater than 500 mg/L, the aqueous waste is first aerobically digested to a BOD less than 500 mg/L. If the BOD is less than or equal to 500 mg/L, the aqueous waste is optionally aerobically digested, but generally processed further as discussed herein below.

In some embodiments, the aqueous waste is aerobically digested after separation of solids. In some embodiments, the aqueous waste is homogenized after crushing. The aqueous waste can be aerobically digested by any suitable method. In some embodiments, aerobic digestion is performed in a refluxed aerobic reactor, allowing aerobic bacterial decomposition of at least some waste components to release carbon dioxide into the waste.

In some embodiments, aerobic digestion is performed under conditions that minimize removal of produced carbon dioxide from the aqueous waste, in such a way, the oxygen content of the aqueous waste during aerobic digestion is maintained at a relatively low level, while carbon dioxide content is maintained at a relatively high level. The energy needs of the aerobic reactor are relatively modest as no energy is used for compressing air. Further, a comparatively low amount of carbon dioxide is released into the atmosphere.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the scope of the appended claims.

Citation or identification of any reference in this application shall not be construed as an admission that such reference is available as prior art to the invention. Section headings are used herein to ease understanding of the specification and should not be construed as necessarily limiting.

1. An aerator kit, useful for aerating carbon-containing aqueous waste, comprising:
a body component including:
a solid wall defining a fluid-flow channel with a longitudinal axis between a proximal aperture and a distal aperture thereof; and
at least one peripheral hole providing fluid communication between the outside of said wall and said fluid-flow channel of the body component,
at least one nozzle insert, physically separate from said body component, each said nozzle insert including:
a solid wall defining a truncated conical fluid-flow channel with a longitudinal axis convergent from a nozzle insert inlet to a nozzle insert outlet smaller than said nozzle insert inlet;
a distal outer portion having a truncated conical cross section having a length and ending at said nozzle insert outlet; and
a proximal mating portion,
wherein each said nozzle insert is configured to mate with said body component, thereby together constituting a single physical unit, where:
said mating portion of said nozzle insert mates with said proximal aperture of said body component;
said distal outer portion of said nozzle insert is located inside said fluid-flow channel of said body component; and
said distal outer portion of said nozzle insert extends beyond, without blocking, said at least one peripheral hole,
wherein a first of said least one of said nozzle inserts is configured so that when said body component and said nozzle insert are mated, air forced into said inlet of said nozzle insert while said body component is immersed in a liquid emerges from said nozzle insert outlet as a gas stream so as to draw said liquid through at least one said peripheral hole into said gas stream; and
wherein a second of said at least one of said nozzle inserts is configured so that when said body component and said nozzle insert are mated, liquid forced into said inlet of said nozzle insert while said body component is located in ambient air emerges from said nozzle insert outlet as a liquid stream so as to draw said ambient air through at least one said peripheral hole into said liquid stream.

2. The aerator kit of claim 1, wherein said at least one peripheral hole being perpendicular to said longitudinal axis.

3. The aerator kit of claim 1, further comprising:
screw threads on at least a portion of the inside of said solid wall of said body component near said proximal aperture; and
constituting at least a portion of said mating portion of a said nozzle insert, screw threads on the proximal outside portion of a said nozzle insert configured to mate with said screw threads of said body component.

4. The aerator kit of claim 1, wherein:
said fluid-flow channel of said body component has a diameter proximal to said proximal aperture of said body component sufficiently large to allow said mating portion of a said nozzle insert to slidingly pass thereinto; and
said fluid flow channel includes, on an interior side thereof, a stop, located distally from said proximal aperture of said fluid-flow channel to preventing sliding of said mating portion of a said nozzle insert past said stop.

5. The aerator kit of claim 1, said body component of said body component and a said nozzle insert configured so that when mated, a proximal end of said nozzle insert is flush with a proximal end of said wall of said body component, such that no portion of said nozzle insert extends outside of said body component.

6. The aerator kit of claim 1, said body component configured for serial linking to at least one additional such body component.

7. The aerator kit of claim 6, said body component configured so that when serially-linked with a said additional such body component, the respective said fluid-flow channels of said body components are coaxial.

8. The aerator kit of claim 1, wherein the cross-sectional size perpendicular to said longitudinal axis of said fluid-flow channel of said body component varies along the length thereof.

9. The aerator kit of claim 1, wherein in cross section that includes the longitudinal axis and distal from said at least one peripheral hole, the fluid-flow channel of said body component has_the shape of a convergent-divergent nozzle.

10. The aerator kit of claim 1, wherein in said first of said at least one said nozzle inserts in the plane perpendicular to said longitudinal axis of said fluid-flow channel of said body component that includes said nozzle insert outlet when said nozzle insert is mated with said body component, a cross sectional area of said fluid-flow channel of said body component is at least about nine times greater than a cross sectional area of said nozzle insert outlet.

11. The aerator kit of claim 1, wherein in said first of said at least one said nozzle inserts in the plane perpendicular to said longitudinal axis of said fluid-flow channel of said body component that includes said nozzle insert outlet when said nozzle insert is mated with said body component, a cross sectional area of said fluid-flow channel of said body component is at least about sixteen times greater than a cross sectional area of said nozzle insert outlet.

12. The aerator kit of claim 1, wherein in said second of said at least one said nozzle inserts in the plane perpendicular to said longitudinal axis of said fluid-flow channel of said body component that includes said nozzle insert outlet when said nozzle insert is mated with said body component, a cross sectional area of said fluid-flow channel of said body component is between about two and about five times greater than a cross sectional area of said nozzle insert outlet.

13. The aerator kit of claim 1, wherein in said second of said at least one said nozzle inserts in the plane perpendicular to said longitudinal axis of said fluid-flow channel of said body component that includes said nozzle insert outlet when said nozzle insert is mated with said body component, a cross sectional area of said fluid-flow channel is between about three and about four times greater than a cross sectional area of said nozzle insert outlet.

14. The aerator kit of claim 1, said fluid-flow channel of said body component configured so that when said body component is not mated with a said nozzle insert, liquid forced into at least one of said proximal aperture and said distal aperture while said body component is located in ambient air forms a liquid stream that passes said at least one peripheral hole to draw ambient air through at least one said peripheral hole into said liquid stream.

15. The aerator kit of claim 14, said fluid-flow channel of said body component comprising three sections:
a first nozzle section that in cross section including said longitudinal axis of said body component defines a truncated cone convergent from near said proximal aperture towards said distal aperture;
a second nozzle section that in cross section including said longitudinal axis of said body component defines a truncated cone convergent from near said distal aperture towards said proximal aperture; and
a parallel-walled linking section providing fluid communication between the narrow end of said first nozzle section and the narrow end of said second nozzle section,
wherein said at least one peripheral hole emerges in said fluid-flow channel at said linking se
